(19) United States
(12) Patent Application Publication
(10) Pub. No.: US 2014/0164259 A1
(43) Pub. Date: Jun. 12, 2014

(54) AVERAGE SALVAGE VALUE METHOD AND APPARATUS

(71) Applicants: Anthony B. Hildreth, Aurora, IL (US); Andrei F. Tamas, Hinsdale, IL (US)

(72) Inventors: Anthony B. Hildreth, Aurora, IL (US); Andrei F. Tamas, Hinsdale, IL (US)

(73) Assignee: INSURANCE AUTO AUCTIONS, INC., Westchester, IL (US)

(21) Appl. No.: 14/030,680

(22) Filed: Sep. 18, 2013

Related U.S. Application Data
(60) Provisional application No. 61/702,601, filed on Sep. 18, 2012.

(51) Int. Cl. G06Q 30/02

(52) U.S. Cl. CPC G06Q 30/0278
USPC 705/306

(57) ABSTRACT

A method and apparatus for searching a database of vehicle values for a damaged or donated vehicle to determine a value of a vehicle of interest. The search permits free text searching and performs autocomplete of search terms as well as autocomplete of related search terms. Search results are determined after search terms are deciphered by the algorithm and those deciphered terms are then used to query the database to identify matching information.

### CROSS-REFERENCE TO RELATED APPLICATION

This application claims the benefit of U.S. Provisional Patent Application Ser. No. 61/702,601, filed Sep. 18, 2012, which is incorporated herein by reference.

### BACKGROUND OF THE INVENTION

1. Field of the Invention

The present invention relates generally to a method and apparatus for determining a value of a damaged or donated vehicle, and more particularly to computer executed method and computer apparatus for identifying a value of a damaged or donated vehicle from a database of values of damaged and donated vehicles.

2. Description of the Related Art

Persons and companies who deal with damaged and donated vehicles, such as wrecked vehicles, would like to know the value of a damaged vehicle. For example, a vehicle owner whose vehicle has been damaged, for example as the result of an accident, flood or fire, would like to know how much the vehicle is worth so that the owner may decide whether to keep the vehicle instead of turning it over the an insurance company in return for a settlement. The insurance company would like to know how much the vehicle is worth so that they have an idea of what the vehicle will bring at auction as a salvage vehicle. The salvage auction company would like to know the value of the vehicle and prospective purchasers of the damaged vehicle would also like to know the value of the vehicle.

Users searching to search a database of damaged vehicle values have been forced to enter many detailed items of information about the vehicle to obtain information from the database. For example, the search of the database has asked that the user input the make, model and year of the vehicle, the trim level, the options on the vehicle such as air conditioning or sun roof, an indication of whether the vehicle runs, whether various items were missing from the vehicle such as is the radio/stereo missing, location of the damage and extent of the damage, as well as other information. After entering each of these items of information, the user executes the search and can receive a lengthy listing of entries that meet the search criteria. The user is force to either use the first few items that come up or to review the entire listing of items revealed by the search.

### SUMMARY OF THE INVENTION

The present invention provides a method and apparatus for determining an average salvage value of a damaged vehicle. The method and apparatus utilizes a database of vehicles and vehicle values for damaged vehicles. An inquiry is made of the database using natural language searching to locate comparable vehicles with comparable damage in the database. Vehicles and the damage description is described using common terms without requiring entry of all the possible options to execute the search. For example, the searcher may ask for results on an “'08 Mustang GT with front end damage”, without needing to enter that the vehicle is a Ford make, or that the vehicle includes a sunroof and multi-speaker CD player and without getting into the details of the extent of the front end damage.

User entered search terms are deciphered by the accelerated search algorithm. For example a search of “08 Mustang” will be deciphered as “2008 Ford Mustang”. The deciphered terms are then used to query the database. The resulting data set from the query yields the initial criteria match. In the Accelerated Search, drop down results from the search box show values associated with the appropriate matching terms. A search for “08 Mustang” yields 79 matching results in one example for the Accelerated Search drop down results and on the actual results display page. The search is quick and the results are easier for the user to understand, leading to a more accurate estimate of the salvage value of the vehicle in questions. The results from the matching database query may include only one or a few of the representative vehicles that match the search criteria.

### BRIEF DESCRIPTION OF THE DRAWINGS

FIG. 1 is a functional block diagram of a system according to the principles of the present invention;

FIG. 2 is a schematic illustration of the architecture of a preferred embodiment of an average salvage value system;

FIG. 3 is a graphical display portion from a computer device display of a time period for a search according to the present method and system;

FIG. 4 is graphical display portion from a computer device display of a drop down of showing automatic completion of make and model information;

FIG. 5 is a graphical display portion of vehicle makes and record numbers for each make;

FIG. 6 is a table of search results;

FIG. 7 is a detail view of a vehicle located in a search;

FIG. 8 is a graphical display portion of an average salvage value search result;

FIGS. 9A, 9B and 9C are portions of a process flow chart illustrating the determination of an average salvage value;

FIG. 10 is a portion of a search table according to an aspect of the invention;

FIG. 11 is a portion of a search suggestion table;

FIG. 12 is a portion of a search suggestion series table;

FIG. 13 is a portion of a suggestion table;

FIG. 14 is a portion of a synonyms table;

FIG. 15 is a graphical illustration of a distinct values table;

FIG. 16 is a graphical illustration of an autocomplete function;

FIG. 17 is a portion of a display screen showing a result count;

FIG. 18 is a portion of a display screen showing an automatic search increase;

FIG. 19 is a screen shot of a computer display showing a preview of search results;

FIG. 20 is a screen shot of a computer display showing a selection drill down;

FIG. 21 is a screen shot of a computer display showing a result of a selection drill down;

FIG. 22 is a screen shot of a computer display showing preservation of search count values; and

FIG. 23 is a schematic diagram of a computer system for performing the present method.

### DETAILED DESCRIPTION OF THE PREFERRED EMBODIMENTS

A method and apparatus for providing a value of an item to a user and in particular to providing the value of a vehicle to a user. The vehicle may be a vehicle donated to a charity or other entity or may be a vehicle that has been damaged in an accident, fire or flood and is being sold or valued as part of an insurance settlement. The user desires to know the value of the vehicle.

The method and apparatus utilize a database of donated and damaged vehicles and their selling price at auction or otherwise. The user is guided through a user interface to permit the user to perform a search of the database. The database uses natural language or free text searching to permit the user to search without the need to fill in lengthy forms or utilize specific words or phrases. Natural language, free text and/or other search methods are used to enable the system to locate the information most likely to meet the user's input. The user is provided with an input screen that has an input area for an unstructured search string. The system interprets the user input and provides the search result based on a search of the database.

The search results are reported with refiners, to enable the user to obtain more specific information on the value of a vehicle if the initial result is not specific enough for the user's needs. The refiners are displayed in the results page so that the user can move up or down in the search results.

The user interface is structured for use on a computer such as the user's desktop, laptop, or workstation computer, such as laptop 210 in FIG. 23. The user interface of another embodiment is structured for use on a tablet computer, smart phone or other mobile device, such as the tablet computer 212. Other computer devices are of course possible. The user interface communicates via a communication network 214 to a server 216 that has access to the database. The communication network 214 can include a LAN, WAN, Wi-Fi, Bluetooth, the Internet or other communications network. The server 216 may include multiple server devices that access computer readable storage media. The user's computer device 210 or 212 and the server 216 both include at least one processor that executes computer programs to perform the present method.

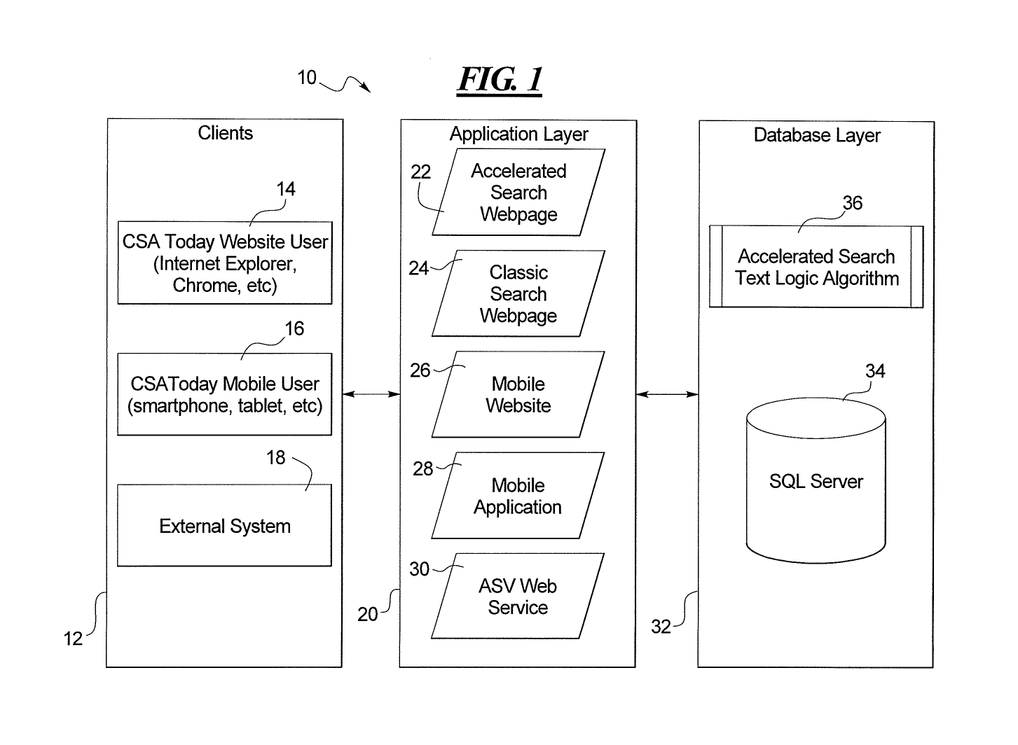

An example of a system 10 according to the present method and apparatus is shown in FIG. 1. The system 10 has a client level 12 that includes a website client 14 for access by a computer device running a browser program such as Internet Explorer or Chrome, a mobile client 16 is provided for access by smartphones, tables, etc., and an external system 18. The system 10 includes an application layer 20 that includes an accelerated search webpage 22, a classic search webpage 24, a mobile website 26, a mobile application element 28 and an average salvage value (ASV) web services element 30. A database layer 32 includes a SQL Server component 34 and an accelerated search text logic algorithm 36.

The search is performed after the terms entered by the user are deciphered by the algorithm 36. The deciphered terms are applied to the database 34 to find the appropriate matching information. The results are an abbreviated data set of the full database. The abbreviation only limits the results to appropriate data based on applied search terms.

Salvage value is an estimate which can help determine the cost basis for a vehicle. If a vehicles value is set higher than the likely sale amount, the salvage provider could incur fees for rerunning the vehicle for auction. If set too low, the vehicle may be offered at a cost below what it could have sold for. As such, an accurate estimate of value for the vehicle is desired.

A user interface web site or other user interface, one of example of which is the CSAToday web site, includes Average Salvage Value (ASV) Tool method and apparatus determines an estimated salvage value for a vehicle based on past sales of similar vehicles. The tool aids the salvage provider by providing historical information for vehicles sold by the auction service or another company across all salvage providers. The available sale data and the selection criteria entered by the provider drive the ASV result.

The ASV Redesign is a complete revamp of a current ASV tool in CSAToday, a web site including a user interface to an auction service data, allowing for quicker retrieval and more accurate information.

The preferred embodiment allows the user to dynamically drill down to designated vehicle sales statistics. The ASV redesign incorporates an accelerated search engine or similar search technologies into the process to provide greater capacity, flexibility, and intelligence. A search with refiners provides a faster and more accurate search compared to the “standard” search capabilities.

Embodiments of the apparatus and method provide mobile device functionality including offering the new search capability in the mobile application, or app.

The present method and apparatus provide enhancements to the VIN decode process with better or additional products that support more vehicle types (i.e. specialty vehicles). VIN limitations of 17 digits are removed.

An average salvage value report provides average sale prices of vehicles based criteria. This will help establish salvage value on a vehicle that may be assigned to an auction service such as IAA or other vehicle auction service.

The user interface to the program provides easy navigation for the user to enter a free text as an advanced search to get the results. The user can navigate through various kinds of refiners displayed on a page to drill down or drill up the results.

The following changes have been made for ASV—a selection criteria page, a new option to select multiple models, regions and loss types in the criteria page, and a new advanced search feature is added for user convenience.

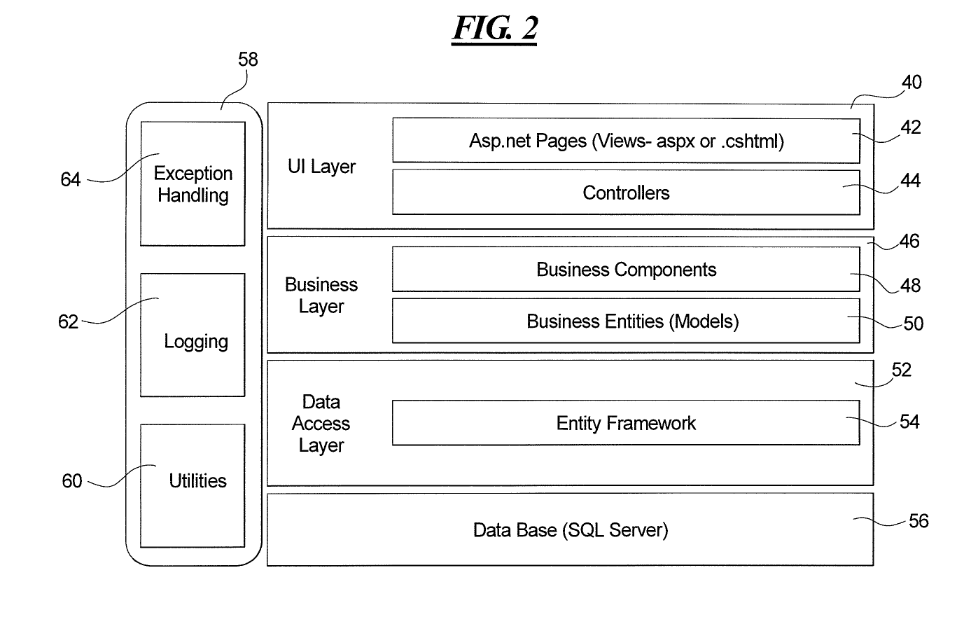

FIG. 2 is an illustration of the architecture of an average salvage value system. In particular, a user interface layer 40 has asp.net pages 42 and controllers 44. The user interface 40 sits on top of a business layer 46 that has business components 48 and a business entities or models 50. The business layer 46 sits on a data access layer 52 that includes an entity framework 54. These layers sit on a database 56, which here is a SQL server database. Spanning the four layers is a block 58 that includes utilities 60, a logging element 62 and an exception handling component 64.

The components of an exemplary embodiment of the system use: Dot net 4.0 Framework, Visual studio—2010, SQL server 2005 as the database backend, Language used is C#, MVC 3.0, Razor View Engine, JQUERY, and Version Control using Team Foundation Server (TFS). Other languages and tools are of course possible.

At the user interface, the system uses auto complete of the user's entry. Suggestions are provided based on words the user has typed. Deciphered search terms are applied to the database and a count is previewed of matching data from the Accelerated and Classic Search screen before results page is displayed. The search is directed to vehicle year, make, series, loss type and damage type. Tables of descriptions are used as suggested words. In a preferred embodiment, the tables of suggested words include less than 10,000 words and in one embodiment the table includes about 6,000 words. Of course, tables of different sizes can be used. Different word combinations are suggested. Synonyms are provided as a look up table. Businesses can provide a list of words to use as look up words.

A database of vehicle sales records can have a large number of entries. In one example, about three million detailed entries are provided in a database of damaged vehicle sales. Many of these records are similar to one another in terms of the vehicle information, damage information and value information. According to a preferred embodiment, a smaller number of records is provided for searching as distinct values. By extracting distinct values from the larger database and performing the search on the distinct values portion, a faster search time is possible with lower usage of system resources. The distinct values table of one example includes approximately 6,000 sale records.

Refiners are provided as additional columns in the distinct values table. The refiners may include information on damage type, airbag deployment, region, etc.

The distinct values table serves as the basis for the auto complete function or for instant results in drop down lists. The distinct values table also enables the user to enter search terms in any order including entering any refiners.

The search terms permit a basis search with the autocomplete function. Multiple word search terms are possible to describe a value in the table, such as damage location or vehicle model. The use of up to five search terms is possible in one embodiment while entry of an unlimited number of search terms is possible in another embodiment. Synonyms are acceptable to describe search items, as are homonyms. Variations in spelling and abbreviations are permitted. For example, a user may enter “Toyota Cam” in the search field, which is interpreted by the system as a Toyota Camry. The user can use wildcard search terms or can provide a range of values. When some search terms are recognized by the system, the system provides additional search terms as a drop down box to select from. The auto-select function can work not only in a forward direction but also is mapped to work in a backward direction, for example to auto-select the broader category “Ford” if the more specific search term “Mustang” is entered by the user. Dates and years can be abbreviated to double digits.

According to a preferred embodiment, the system can derive the make of the vehicle from the model if the make is unique to the model, the system can derive the model from the make if the model is unique to the make, and can derive the make and model from the series if the series is unique to a make and model.

The present method and system allow the user to dynamically drill down to designated vehicle sales statistics. The ASV redesign incorporates FAST Search or similar search technologies into the process to provide greater capacity, flexibility, and intelligence. A search with refiners provides a faster and more accurate search compared to the standard search capabilities. Mobile ASV functionality is contemplated, as are enhancements to the VIN decode process with better or additional products that will support more vehicle types (i.e. specialty vehicles) are within the scope of the present method. VIN limitations of 17 digits are dealt in a contemplated enhancement.

The auction company system is used to determine the Average Salvage Value for a given vehicle based on past sales of similar vehicles within a given timeframe. The salvage value is an estimate based on past sales. The accelerated search will not limit vehicle types. Images displayed to the user may be that of the “Damage Close Up” slot which is the sixth image in the photo set order in one example.

In a preferred embodiment, the database includes motorcycle information and specialty vehicle information. Unit tests and regression tests are performed to concentrate the accuracy of the sales return calculations. The use may select a single maker of vehicles and the system may include multiple models by that maker. The model value may be considered as a starting value, so that all higher valued or more recent model names are included. When the results are displayed in a results page, the results page may also display one or more of the following information, the number of vehicles selected, the lowest sale price, the average sale price, the average percent ACV, and the highest sale price. For results to be displayed, at least one vehicle matching criteria must be found. The ASV calculations are based on straight averages in a preferred embodiment.

In a search bar, the user may select the vehicle year, make, model, series, damage and loss type. Additional selection requirements include indicating if the vehicle can run and be driven, the odometer reading, the airbag deployment status, an indication of whether the vehicle starts, and the sales document type. Additional search refiners may be selected from a pop up box for selection. The additional refiners cay add or remove refining search terms. The refiners can apply to all or to just some of the search results.

Vehicle detail pages may be displayed to show details of the vehicles by selection of the vehicle on a vehicle summary page that is displayed as a search result.

The user may input an ACV (actual cash value) which is used by the system to calculate salvage value. The system may exclude a vehicle from the search results if the ACV is less that the amount the vehicle sold for, although this need not be the case. A user may exclude individual vehicles from the results and from the calculation of the ASV. The search results may be output, such as by printing.

If a search results in an indication that no match is found, the search scope is expanded to other regions of the country and a wider date range. The search results can be customized by area, state, or time period. Alias region searching may be provided as user define regions rather than preset regions. The user may select whether vehicle images are displayed or not in the vehicle detail page.

In a preferred embodiment the database includes the following information, salvage id, sale date (bid accepted date), sale price, sale days aged, ACV (user entered or black book value), ECR, branch number, VIN (Valid), vehicle type, vehicle year, vehicle make, vehicle model, vehicle series, mileage, engine type, keys, key fob, starts (check in value?), repair estimate, loss type, primary damage type, secondary damage type, run and drive (auction center value), air bags deployed, customer Type, title type, and missing parts indicator.

The search criteria can designate historical periods for searching, for example in three month increments. For example, the increments may include vehicles sold increments of: 1 month, 3 months, 6 months, 9 months, 1 year, 1 year and 3 months, and 1 year and 6 months. FIG. 3 shows an example of a slider for indicating a search history increment, including a time line 66 and an indicator 68 that may be moved along the timeline 66 by the user. The user may also select a model year or a consecutive range of model years. The range may be limited to five years or may extend from the current year to as early as needed. The user may select a loss type or to select multiple loss types in the search. The user may be able to select on or more regions from which to obtain sales information. The selection criteria may be saved by the user. The search year may be entered by the user as a two digit number. Homonym searching is enabled, as is derived make searching, where the maker may be derived by entering a model name.

In FIG. 4, a search suggestion box 70 is shown in which auto-complete operates so that entry of a first portion 72 of a search term, here “Toy” will be completed to “Toyota” 74. The completion of the search term 74 for the maker, here “Toyota”, will populate the fields for the models 76 by the maker, here Corolla, Corona, Half ton Pickup, Highlander, and Landcruiser SW. Of course, other years or other makers will result in other models being populated. The selection of a make and/or model may display the number of such vehicles in stock from which to choose.

The system is configured to recognize a VIN (vehicle identification number) as such when entered into the search field. The system will decode the VIN to determine a year, make and model and series. If an invalid VIN is entered, the system requests that the user enter the make and model or enter a valid VIN. Entry of a partial VIN is recognized and may result in the system performing a search based on the partial VIN.

An accelerated search mode is provided as well as a classic search mode. The user may select between the search modes used.

The search results are displayed to the user along with the user entered search criteria. The user may select the display of the selection criteria used, the summary search results, the detail search results, or the average cash value estimates and calculated salvage value. An average salvage value result is returned even if only one vehicle matches the search criteria. The displayed results may include the highest and lowest sales prices of matching vehicles. In a preferred embodiment, the results display includes an indication of the total vehicles selected, the lowest sales price, the average sales price, the average percent of actual cash value, the highest sales price and the selection period of the vehicles sold. Averages are calculated as simple averages and the values may be rounded off.

The user may exclude vehicles from the calculation. The calculation may take into consideration the repair estimate value and the user actual cash value.

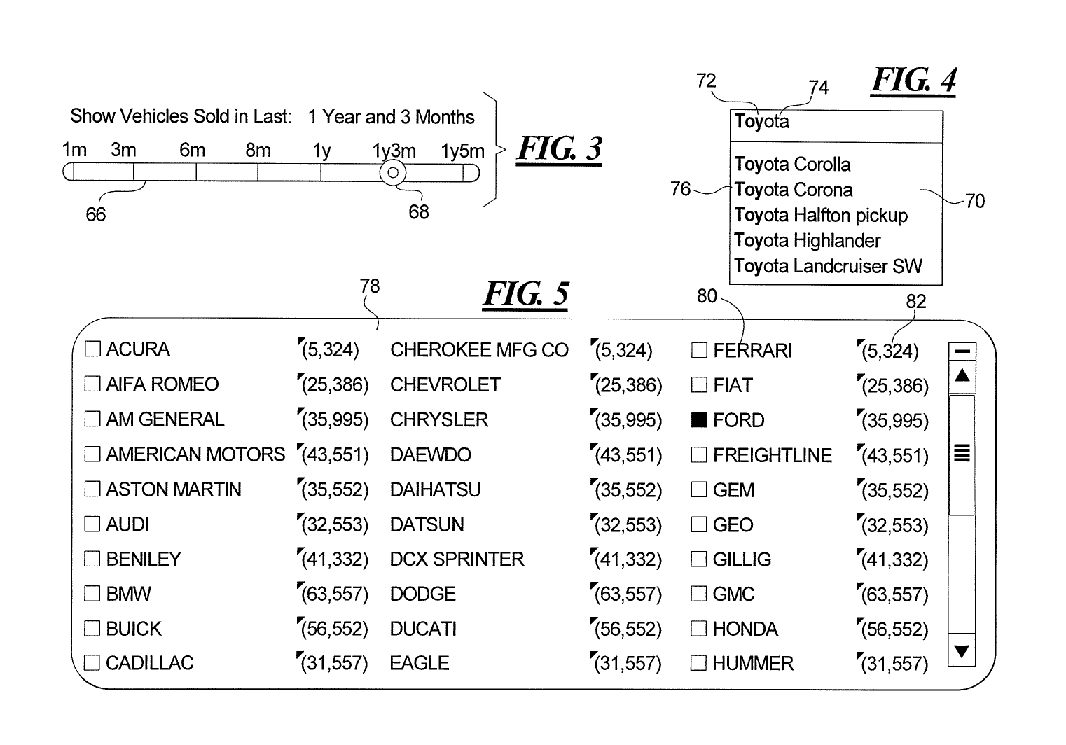

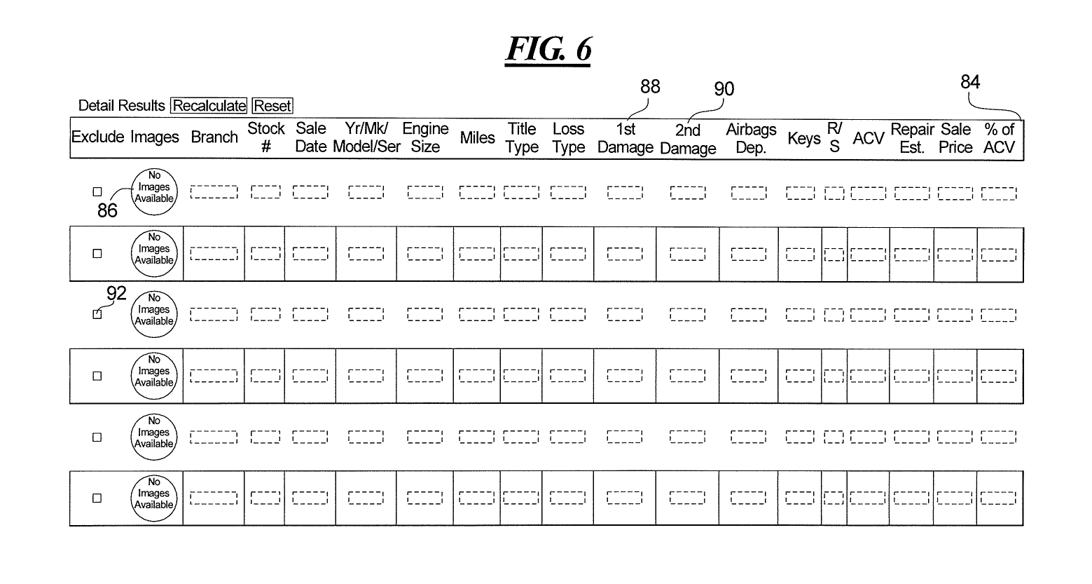

The user selection screen may be populated with additional information from the database. For example, in FIG. 5 a listing 78 of vehicle makers 80 includes an indication 82 of the number of vehicles in the database by that maker. Other information may be displayed to the user as well.

A detail display is provided for the results, including a listing that includes an image of the vehicle, year, make, model, series, branch, engine size, odometer reading, loss type, primary damage, ACV, sold date, sale price and percentage of ACV. Vehicles may be excluded by the user and the results recalculated. A reset command will return the excluded vehicles to the result. The user may display the results by any of the identified information. The user may change the number of results displayed per page.

In FIG. 6 is shown a listing 84 of search results that includes links 86 to images of the vehicles as well as columns of the information listed above. In this layout, the columns include a first damage column 88 and a second damage column 90. The user may exclude any of the listed vehicles by selection of a check box 92.

The vehicle images may be turned off for faster display, or turned on when a high speed connection is available. When an image is displayed as a thumbnail image, the image may automatically enlarge when a cursor is hovered over the image.

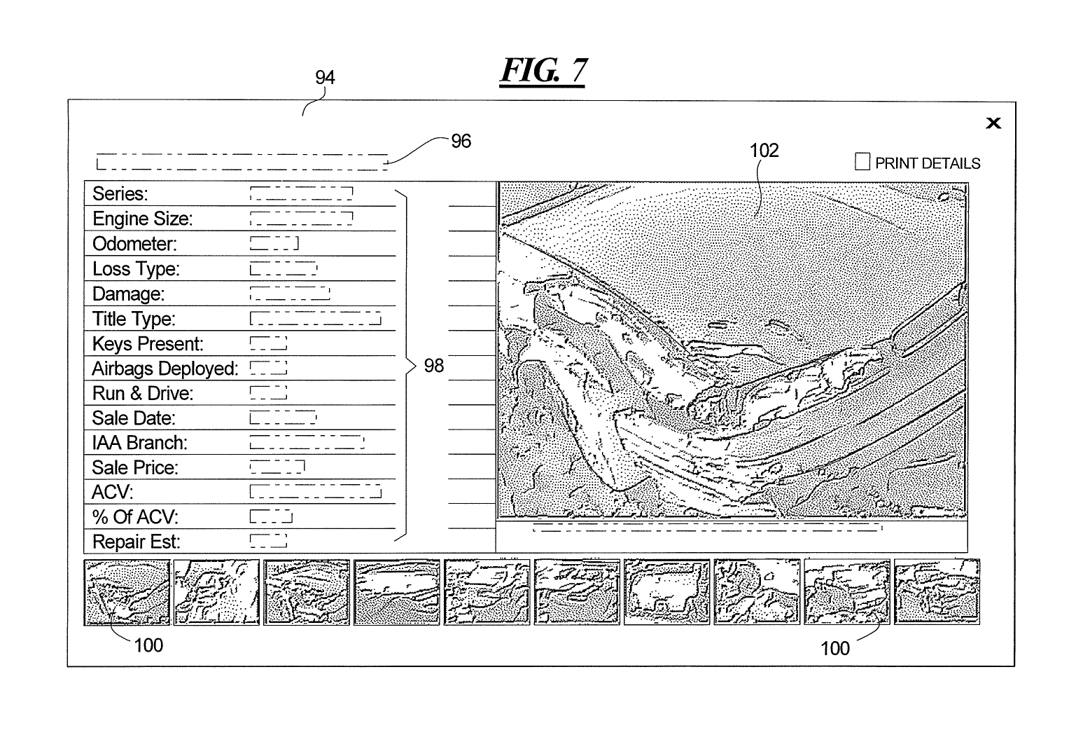

Vehicle details are shown on a separate page. Selection of any of the items in the listing of FIG. 6 brings up the detail view as shown in FIG. 7. The detail view 94 includes vehicle selected 96, and other information 98 including branch, sale date, year, make model, series, engine size, miles driven, title type, loss type, damage type, airbags deployed, key, run and drive, ACV, repair estimate, sale price, and percentage of ACV. A set of photographs 100 of the vehicle are shown, one of which is enlarged in a larger view 102. The user may select the photograph for enlarged viewing. The detailed view 94 may be closed to return to the search results page.

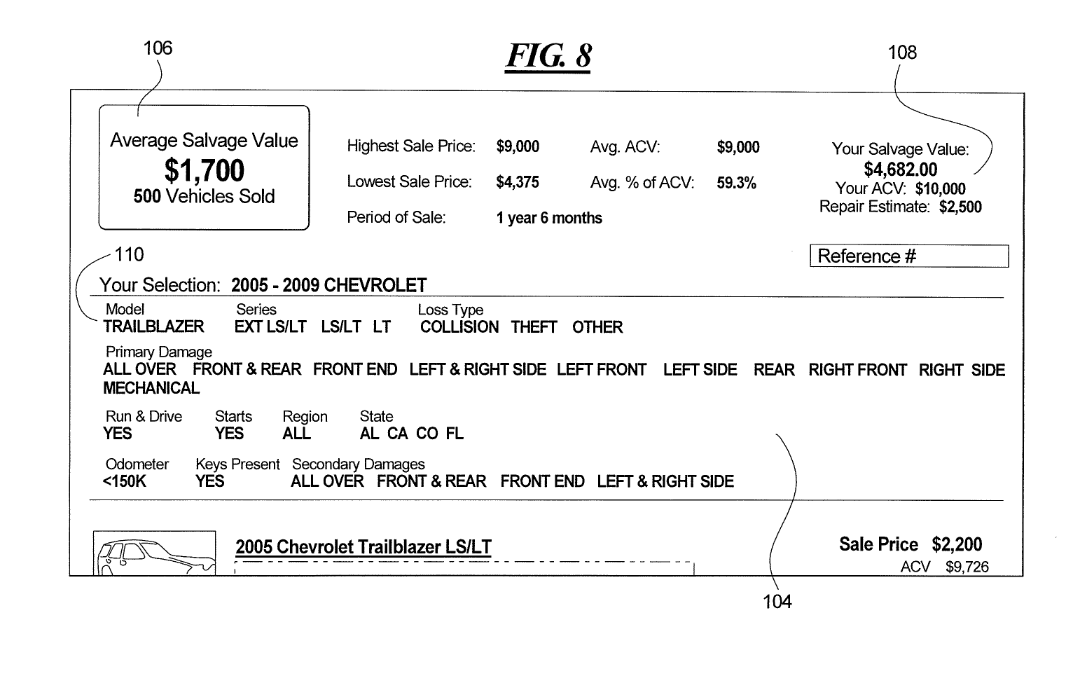

The system may include printer ready formatted pages for printing. A sample printed report 104 is shown in FIG. 8. The printed report includes average salvage value 106 vehicles, a salvage value 108 for the vehicle being searched, as well as a listing 110 of the search criteria used to obtain the results.

The user may customize the values used in the search function, including setting default values for state, sale date and other values. Multiple regions may be selected. Showing or hiding of images or values may be set. The system has the ability to alias the region at the user level.

The system and method searches existing sales data. By use of keyword and indexing, the speed of the searching process is accelerated.

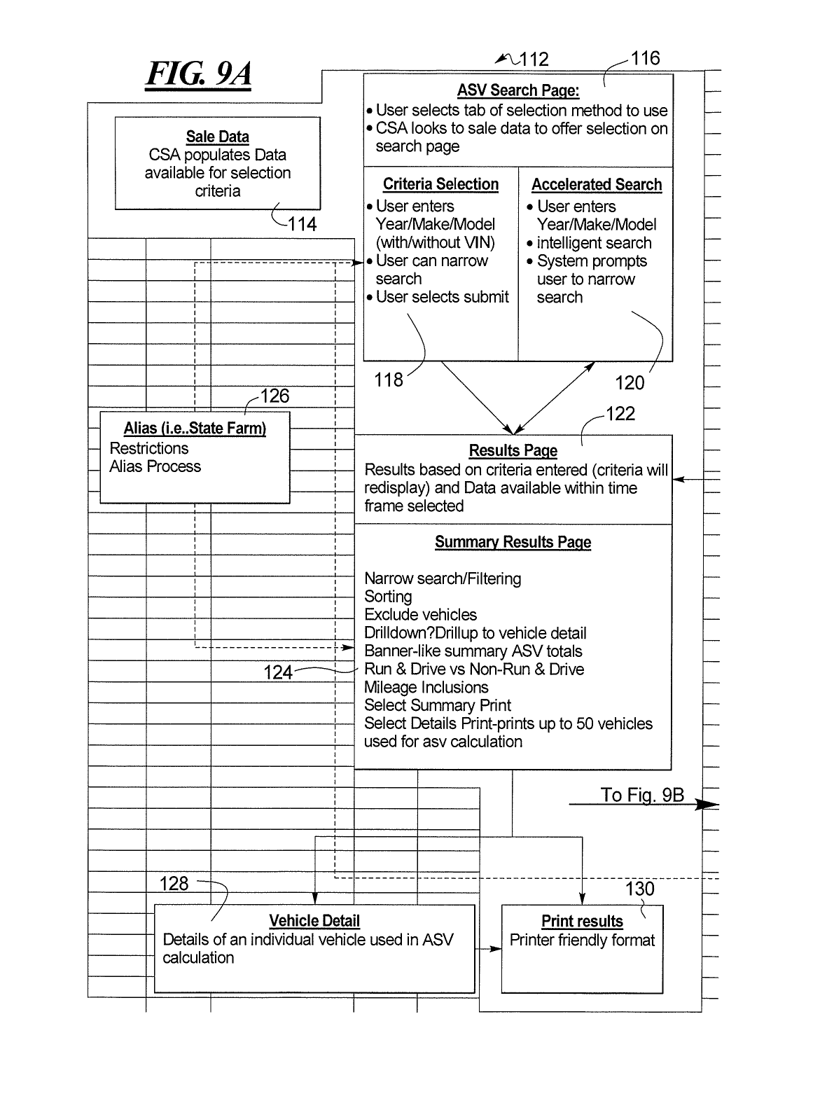

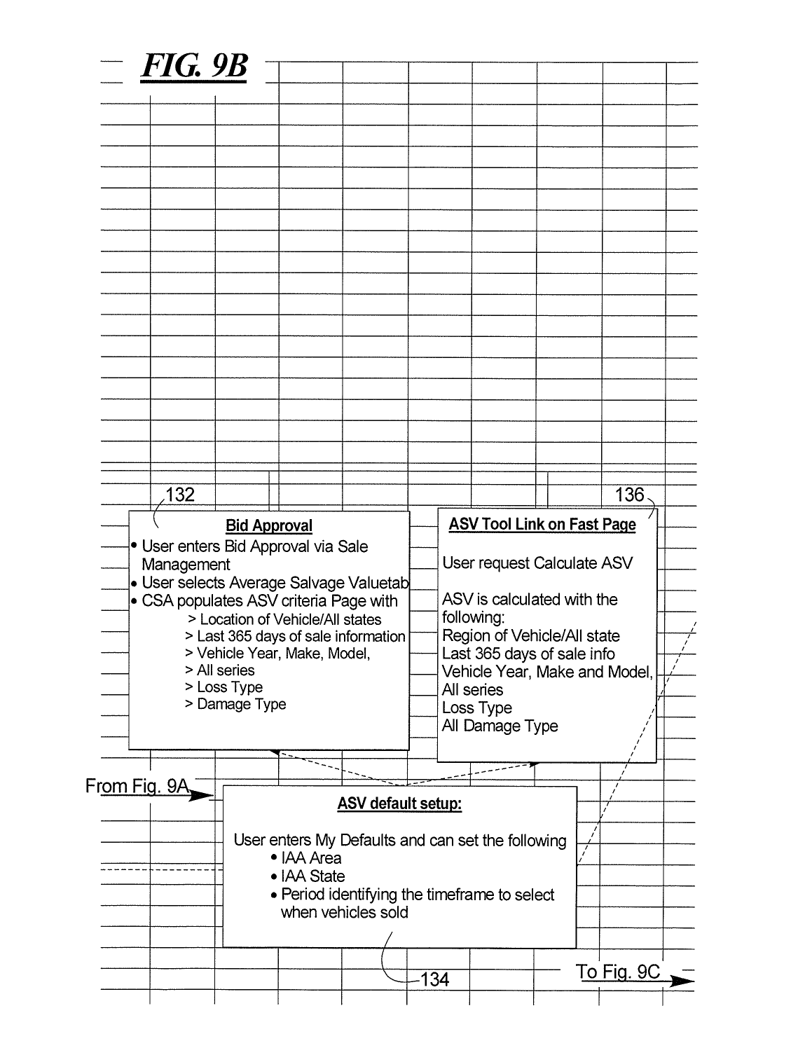

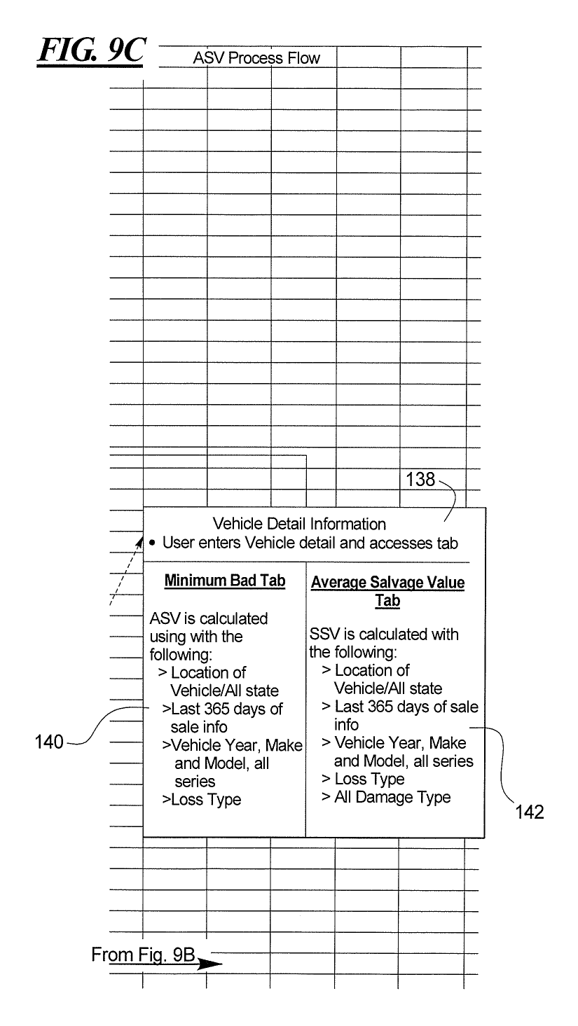

A process flow 112 for the average salvage value is shown in multipart FIGS. 9A, 9B and 9C. Sales data 114 is populated from the available data for the selection criteria. The ASV search page 116 provides that the user selects the method of use, either as a criteria selection 118 or as an accelerated search 120. In the criteria selection 118, the user enters the year, make, model and possibly the VIN, may narrow the search, and submits the search. In the accelerated search 120, the user enters the year, make and model and an intelligent search is performed. The system prompts the user to narrow the search. In a results page 122, the results are displayed based on the criteria entered and the sales data available within the time frame selected. The results page 122 includes a summary results page 124 that permits narrowing of the search and filtering, sorting, excluding vehicles, drilling down or drilling up to vehicle details, a banner summary of ASV totals, a run and drive or non-run and drive selection, mileage inclusions, selection for printing the summary, selection for printing details for a plurality of vehicles that were used in the ASV calculation. The summary results 124 may be subject to restrictions from the alias process 126.

In a vehicle detail 128, the details of the vehicle used in the ASV calculation is provided. A print results function 130 is provided.

Outside the core process and feeding into the results page 122, is a bid approval 132 in which the user enters bid approval for sale management. The user selects the average salvage value tap. The user interface web site populates the ASV criteria page with location of vehicle, state, past year of sales information, vehicle make, model and year, all series, loss type, and damage type. The bid approval 132 is provided with information from the ASV default setup 134 which provides default values for auction service area and state and the period identifying the time frame to select when the vehicle is sold. An ASV tool link on bid fast page 136 is provided. The user request calculates ASV. The ASV is calculated with the region of the vehicle or all state, a year of sales datea, the vehicle year, make and model, all series of the vehicle, the loss type, and all damage types. The fast page 136 is provided with default information 134.

The results page 122 is also provided with vehicle detail information 138 in which the user enters the vehicle detail and accesses a tab. The tabs include a minimum bid tab 140 in which the ASV is calculated using the location of the vehicle or the whole state, a year of sales information, the vehicle make and model and year and all series, and the loss type. An average salvage value tab 142 if selected by the user calculates the ASV based on the location of the vehicle or the whole state, a year of sales information, the vehicle year, make and model and all the series, the loss type and all damage types.

Refiners for the search include the foregoing as well as title type (all, bill of sale, clear, junk, non-repairable, original, salvage, other), ranges for odometer readings, transmission type, primary and secondary damage type, etc.

The database used in an example of the present system and method includes tables updated from the ASV details table as a process of load jobs. The tables includes an ASV search table, an ASV search suggestion table, an ASV search suggestion series table, an ASV suggestion table, and an ASV synonyms table. The tables are utilized to permit the ASV advanced search functionality work faster. For example, the tables are used for auto completing a word that user is trying to type as well as to show the suggestions based on the words that user already typed and to show the counts of understood words.

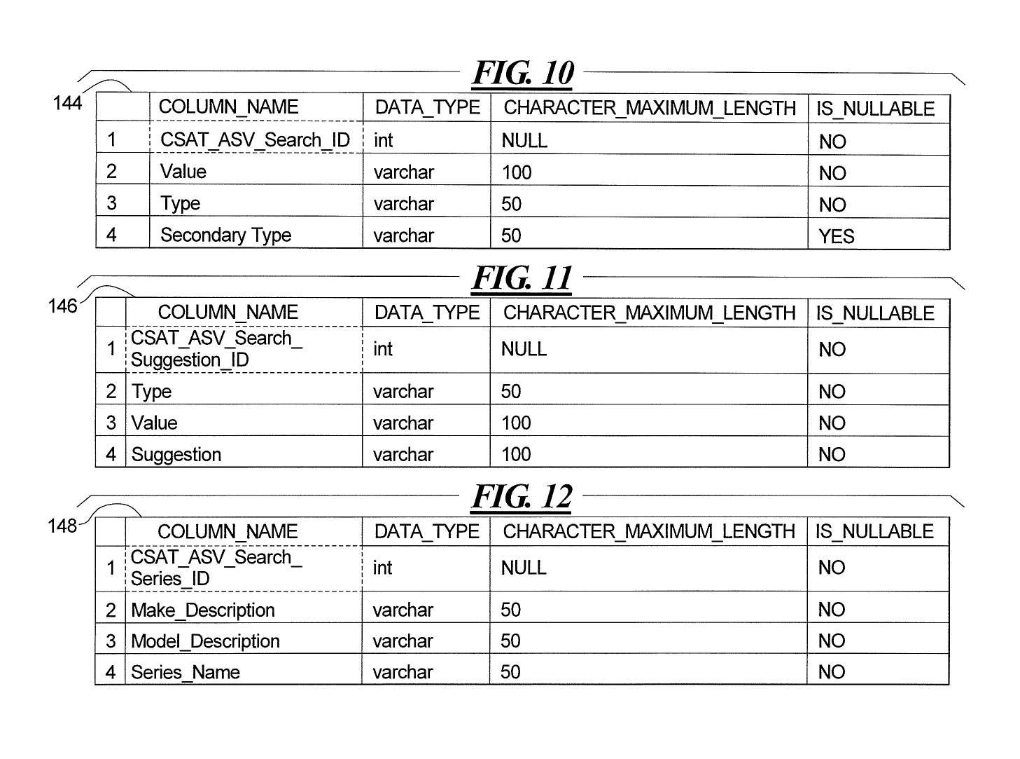

FIG. 10 shows a sample portion of an ASV search table 144. The table 144 is used for storing all distinct make years, makes, models, series, loss type and damage Types. Whenever a user starts typing a letter or letters into a keyboard or keypad, the system will be searching for all the words in this table which starts with those letters. The table 144 is mainly used for auto complete. The schema: select c.COLUMNNAME, c.DATA_TYPE, c.CHARACTER_MAXIMUM_LENGTH, c.IS_NULLABLE from INFORMATION_SCHEMA.COLUMNS c where TABLE_NAME='CSAT_ASV_Search'

In FIG. 11 is shown an example of the ASV search suggestion table 146. The table 146 contains all distinct make—model and model—series combinations that are present in the ASV details table. The table 146 is used for showing the appropriate models if user enters a make already OR to show series if user enters a model.

With reference to FIG. 12, an example of an ASV search suggestion series table 148 is shown. The table 148 contains all distinct make, model and series combinations that exist in the ASV details table. With the table 148 the system shows as suggestions the exact series based on user entered make and model. The ASV search suggestion table 146 and the ASV search suggestion series table 148 are used to suggest words in the ASV advanced search page. In a preferred embodiment, the total number of records in the ASV search table 144, the ASV search suggestion table 146 and the ASV search suggestion series table is less than 10,000.

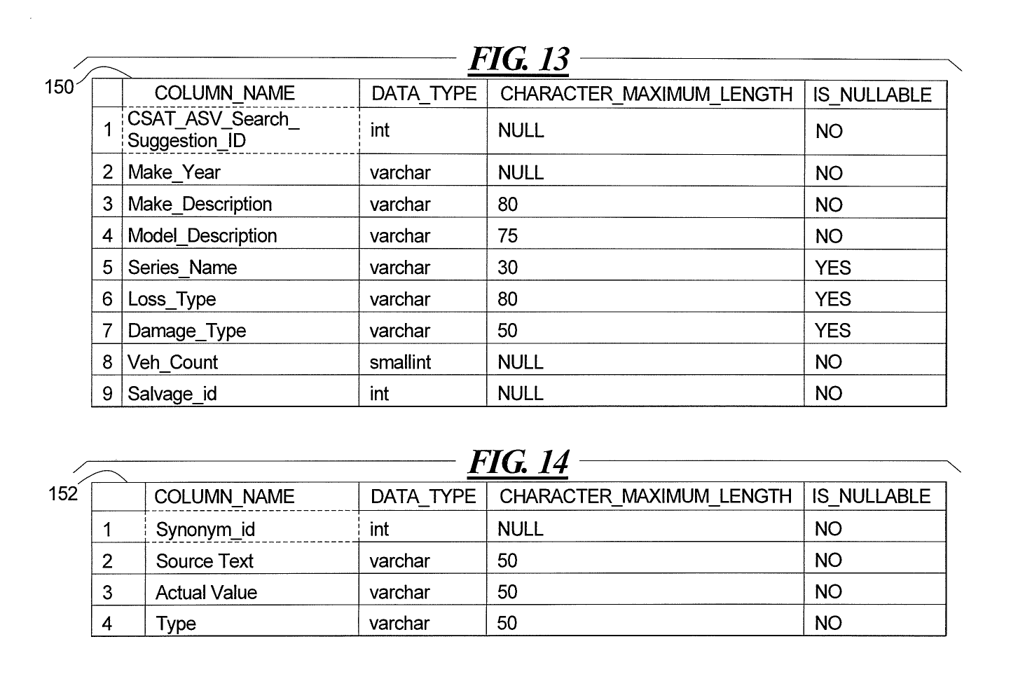

FIG. 13 shows an example of an ASV suggestion table 150. The table 150 is loaded with counts of all different combinations of year, make, model, series, loss type and damage type.

FIG. 14 shows an example of an ASV synonyms table 152. The table 150 has data of different kinds of search words (or short cuts) that a user expects the system to understand. The table 150 works as a look up table. Business provided the list of words to be used as look up words.

The system also uses a few more tables that are indicated as “load” tables. The load tables are used to load the table data as a daily night job. After a successful loading of data into the load tables, there is a flip functionality as a last step in the load job which transfers all the data into the original tables from load tables. If any of these tables is failed loading the data in that job, the original tables will be loaded with the previous day's data, that way the system using these original tables will not fail.

The system includes stored procedures for performing the following functions. A procedure used for advanced search dropdown data fill, that will return the auto complete, suggestions and counts of existing stocks. A procedure used to retrieve a list of stocks for ASV—used in both old and new ASV pages. A procedure that creates a suggestion table for ASV. A procedure that provides data for the ASV report selection screen. A procedure used to get the total counts of stocks based on the selection criteria and the top six images on a basic search of the ASV. A procedure that loads the ASV load tables with fresh data every day. A results procedure that returns the refiners data and details the ASV summary and all the stocks. The results procedure is used for the basic search, the refiners search and the advanced search. A procedure to provide data for a new ASV report selection screen. A procedure retrieves information on the vehicle that is displayed on the vehicle photo page in a table format. A procedure for indexing and renaming the load tables in preparation for use. A procedure for providing data for the ASV report selection screen. A procedure to gather raw ASV details from the DW and ASAP salvage tables. The details of the raw table are used in the determining the ASV calculation. The formula for the ASV calculation is controlled via the system using the raw details.

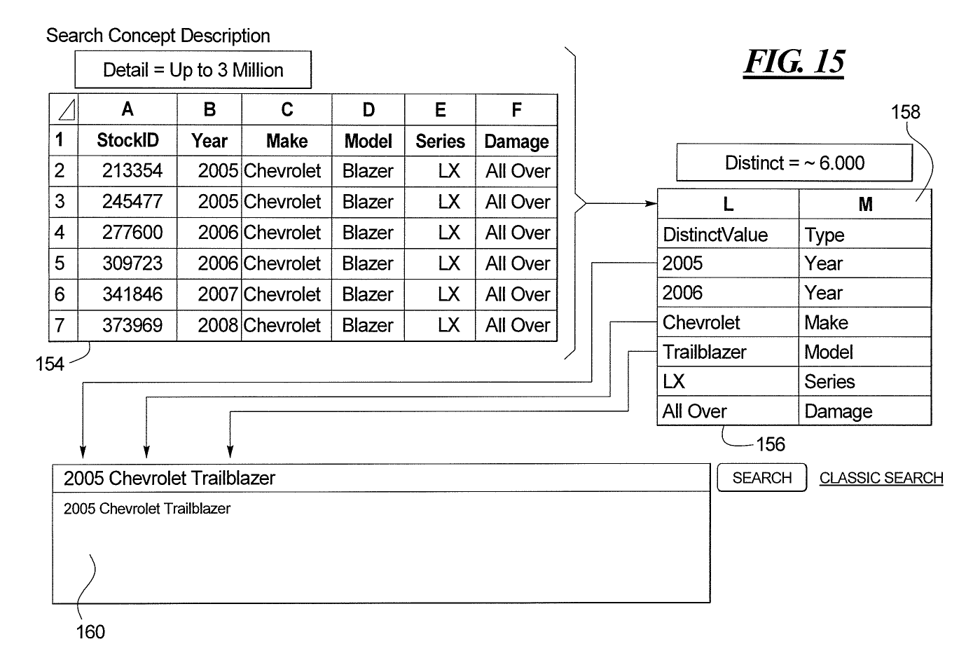

FIG. 15 illustrates the search concepts used in the present method and system. Instead of using the detailed data of a large database 154, for example of approximately three million records, in the autocomplete function, the system uses an extract 156 of distinct values. In one example, the distinct values table has 6,000 records and includes all of the refiner values such as damage types, airbag, etc. The distinct values table 156 has an additional column 158 which helps the system to identify what type of value it is. For example, the type indicator is translated into a definition of the vehicle as shown at 160. The distinct values table 156 serves the data to the auto-complete function for instant results in the drop-down. The system then looks up the distinct value to find the type and that's how the system determines what to search for in the results. This structure produces fast (performing) results and it allows the user to enter the words in any order including entering any refiners.

There are a number of additional features that are built in order for the system to be fully functional: a feature list that includes a basic search with autocomplete—searching for a vehicle using any attributes of year, make, model, series, damage type, etc. For example, the following search terms may be entered by the user and are understood by the system. Ford Mustang GT, Ford Mustang Fire, Fire Mustang, 2011 ford Mustang, 2011 Mustang, Mustang Fire 2011, VIN (first—10 characters). Another feature is to permit use of multiple words to describe some aspect in the search (i.e. to describe the location of the damage, permitted words include: front side, front & rear). This logic will match up to five total words which make up one value such as a model. From a review of the available distinct values, a limit of five words together has been established in one example of the largest set which comprises one search entity. As a further feature, synonyms are used. For example, vw is interpreted as Volkswagen, Chevy is interpreted as Chevrolet.

A wildcard search is provided. For example, a search for “front” is searched as “% front %” from the distinct table which brings back everything that has “front” in it. In addition, the system utilizes priority logic where wildcard searches have lower priority over types matched perfectly from the distinct table. In this example, the system will exclude “Frontier” from the results when a model exists already as a perfect match. A further features is the use of a synonym to multiple values matching. For example, front=front side, front & rear, etc. The system uses a spelling feature accepts variations in spelling by a user. An example of an accepted alternate spelling might be cevrolet=Chevrolet. Numbers may or may not be interpreted as alternate combinations.

Another feature of an exemplary embodiment permits the user to enter a rear range, i.e. 2001-2003. User entries are interpreted as comma delimited values, simply by removing any commas. Homonyms are understood by a preferred embodiment where a same spelling has different meanings, for example, Civic or Denali. Logic is applied to check in priority order for make then model. If a make exists the system will use it as a model, if a model already exists, then the system will use it as a series.

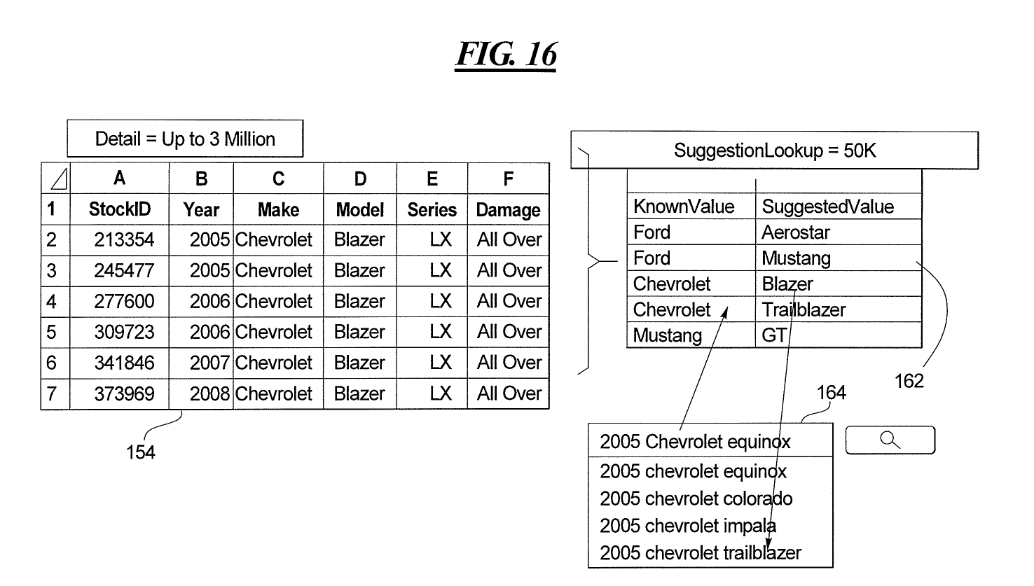

To speed up use of the present system, a feature of next value autocomplete is provided. See FIG. 16. Once the system has recognized a make, the system operates to suggest matching models using an autocomplete function. The full database 154 of detail information has derived therefrom a suggestion lookup table 162. The table 162 provides suggested models for various makes of vehicles. The suggestion table 162 is used to populate a drop down list 164 that is presented to the user as options from which a model may be selected. For example, the system recognizes the make Chevrolet from a partial entry of “Chevrol” and not only autocompletes the maker “Chevrolet” but also suggests models of 2005 Chevrolets including Equinox, Colorado, Impala and Trailblazer. The suggestion Trailblazer as presented by autocomplete may be selected by the user.

The system includes a feature of stock counts. When the system recognizes a year, make and model the system shows counts in a drop-down box. Another feature is instant search thumbnails, in which live result samples are shown by grouped counts with thumbnails.

In a variation on the auto-select function, the preferred system includes auto-select backwards. Rather than moving from the general to the specific, the system also moves from the specific to the general. For instance, where a model is unique to a vehicle maker, auto-select is used to determine the make in the results page. In one example, a user entry of “Mustang” maps the entry to a distinct model so when the system generates the results page the maker “Ford” is shown. If there are multiple makes for that a particular model the system does not do the backwards mapping. Alternately, multiple mappings may be performed to show multiple makes.

The system includes a feature permitting the user to input an abbreviated year. For example, a user may enter a two digit year such as 08 which the system will translate into 2008.

A derived make feature provides that a user types one or more models and if there is not an understood make present, then the system will check if there is only one make for the models. If true then the algorithm will inject that unique make into the logic enabling the make/model search. A derived model (from the make) search is provided. In cases where a make has only one model or as in the case of many trailers there is no model at all (i.e. the value “N/A” may have been entered), the system checks if there is only one model for the understood make and injects that unique model into the logic enabling the make/model search. A derived make and model (from series) search is provided. In cases where a series is understood, the system checks if there is only one make for the models that contain those series and if true it will inject the make and the models that support those series allowing for the make/model/series search.

Thus, there has been shown an average salvage value system and method that provides a report on average sale prices of vehicles based on criteria. An owner or other party responsible for a vehicle may use the ASV system to establish a value of a vehicle. The system is easy to navigate so that the user may enter free text as an advanced search to obtain results and then navigate through various refiners that are displayed in order to drill down or up in the results.

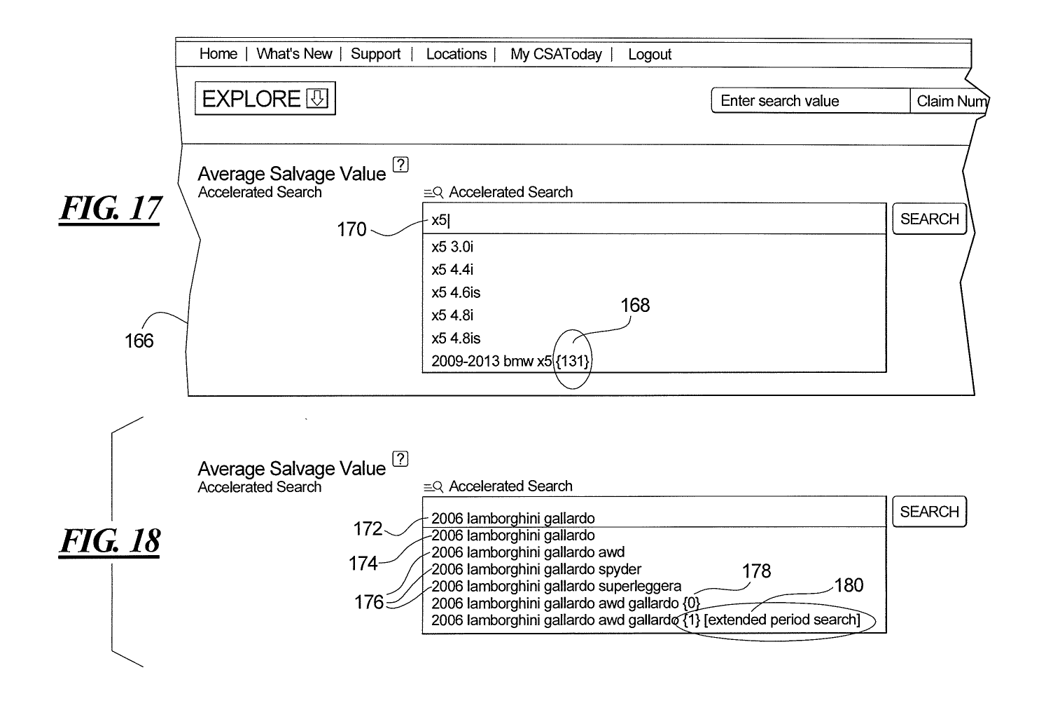

As described above, the search results include a result vehicle count. In FIG. 17, an accelerated search drop-down 166 shows the resulting number of vehicles that are found in the database by executing the query. In the example shown, the user has entered X5 into the search field 170 of the system, the system deciphers that X5 is a BMW X5, it executes a rule to search by default for vehicle sales that have occurred over the last five years when a year is not specified by the user, and the system returns in the drop-down 166 a value {131} as indicated within the oval 168, which is the number of vehicles that match the query. By showing the user the number of records in the system that match the search as the search value is being entered, the user is assured that the search value being entered is a valid one and that sufficient information will be retrieved by the search. The user is shown the result vehicle counts live and instantly as the query is typed, which prevents the user from entering a query with no results or even with too few results to provide a valid sample. The number shown to the user indicates how many vehicles (if any) are found in the database.

In FIG. 18 is shown an automatic increase in the search criteria. When the user enters a search criteria and the system determines that no results are found in the database, the system displays a zero count for records found. However, the system also takes a further step in that the search automatically increases some of the default ranges and determines whether records exist in the extended search. In the illustration, the user has entered a year, make and model of a vehicle to be search into the search field 172. The search term is repeated by the system at 174 and the possible series are identified at 176. A zero indication 178 indicates that no records are found for the entered search term. The system has automatically performed an extended search that has located a record, as indicated at 180. This record has been located by extending the period of time being searched by the system, which is done automatically until a result is obtained. The user is thereby able to find vehicles that match the search criteria when the system increases the ranges of the default search values.

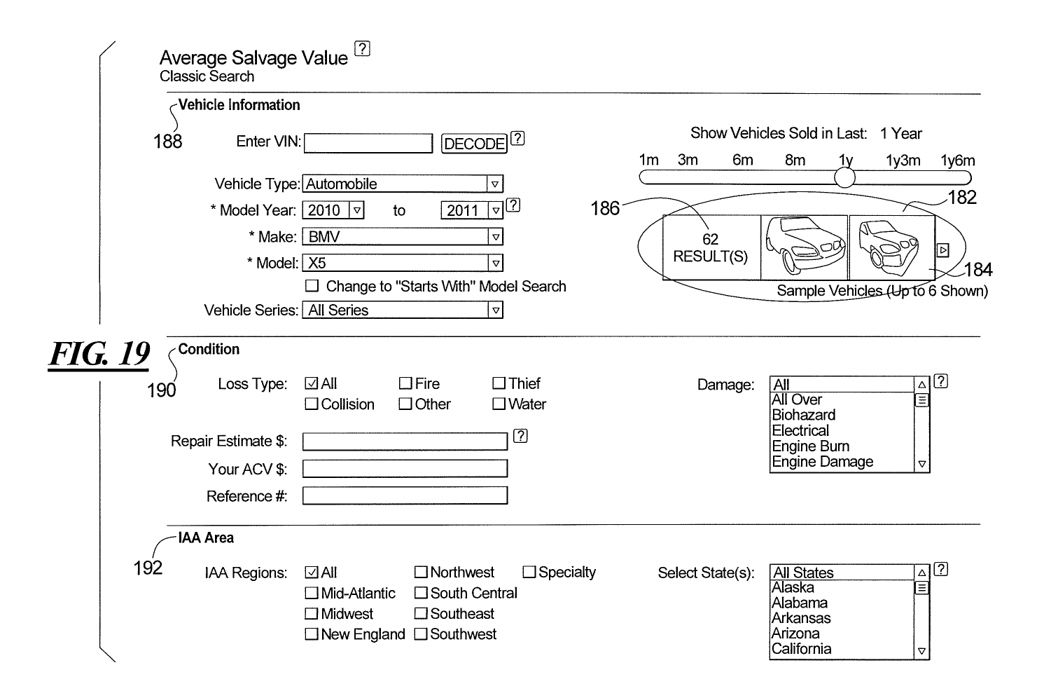

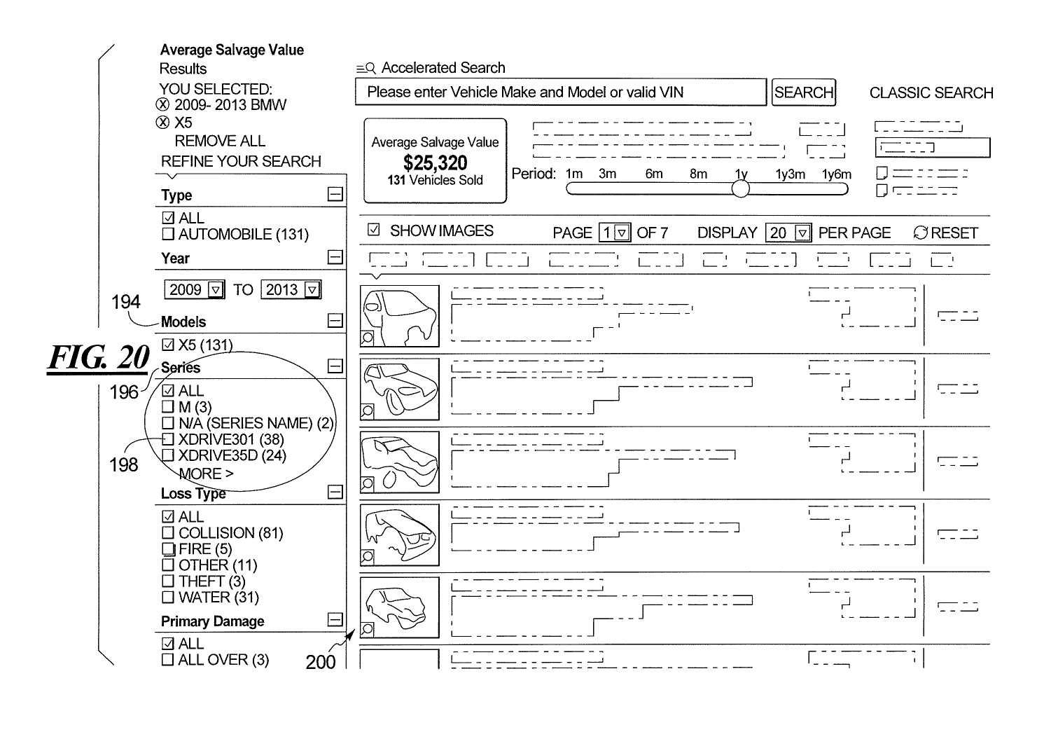

The system performs provides a search preview in a classic search function, as shown in FIG. 19. When the user selects criteria for a vehicle search, a preview window 182 (circled) displays actual thumbnail previews 184 of expected results and numeric result vehicle counts 186. This information provides instant feedback and insight into the total vehicle counts thus eliminating a chance of not getting results in the search. In the classic search function, the search criteria are entered into search fields that include fields for entry of vehicle information 188, condition 190, and area or region 192. The display of the number or records found in the search prevents the hit/miss results scenarios when a user searches for a combination of criteria. It prevents the user from being taken to a separate results page only to find that there is no vehicle found in the search.

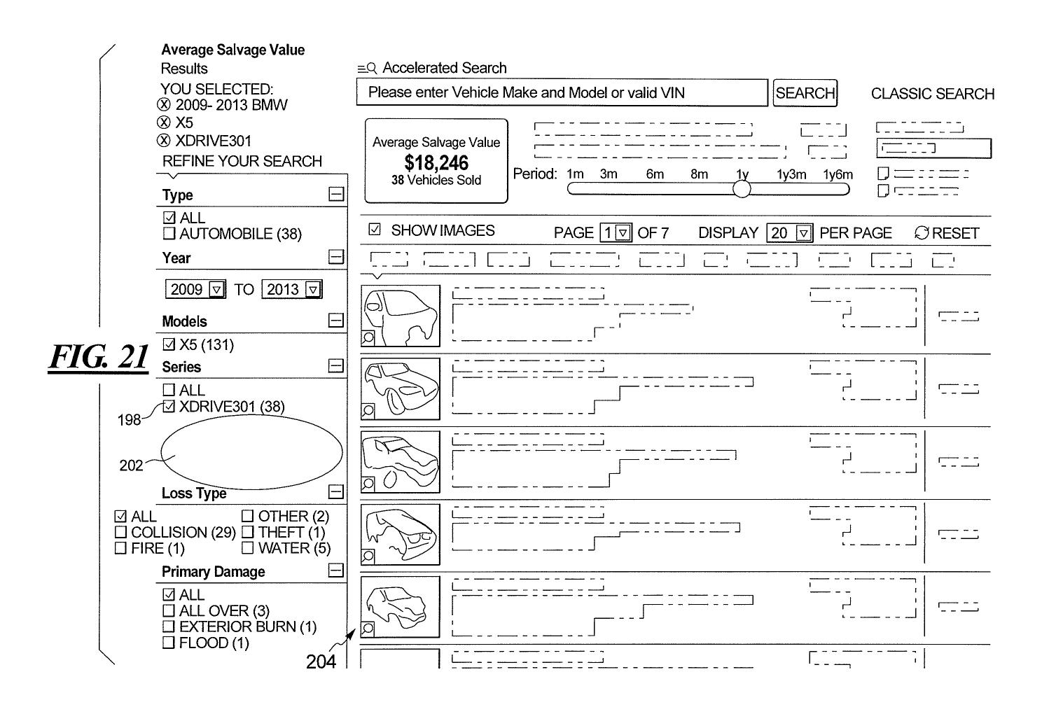

FIG. 20 provides an illustration of a multiple selection drilldown. The ASV results page allows for multiple filter criteria selections while instantly updating all of the vehicle result vehicle counts. This provides an easy and intuitive experience in selecting the appropriate vehicles to provide the average salvage value. Typical filter criteria with instant refreshes have a “drill-down” effect allowing only one selection per vehicle attribute. For example, in the screenshot of FIG. 20, a filtering process is performed for a user who has entered a search term of X5 as the model portion 194 for the search. Within the model is a number of series of X5 vehicles as shown in the series portion 196. The user may drill down in the search by selecting one of the listed series 196. If a user selects the series “XDRIVE30I” 198, and assuming an instant refresh of the counts, all of the other series listed in the series portion 196 such as “M, “XDRIVE35D”, etc. would disappear from the list, preventing the user from selecting these additional Series. The other series may also disappear from the displayed vehicle listing 200. The model thus shows the series for the model by which the results may be further filtered by a user selection.

FIG. 21 shows the search results after the user has selected the series 198. All other series of that model are removed from the view, as shown by the oval 202. Only vehicles of the selected series are show in the vehicle list 204.

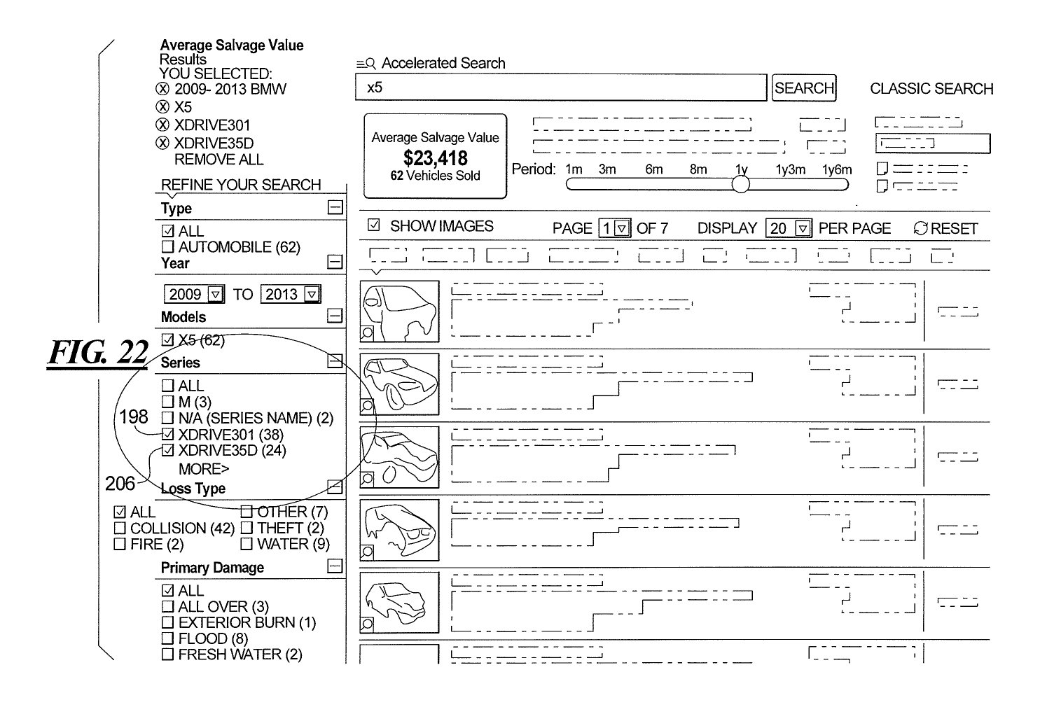

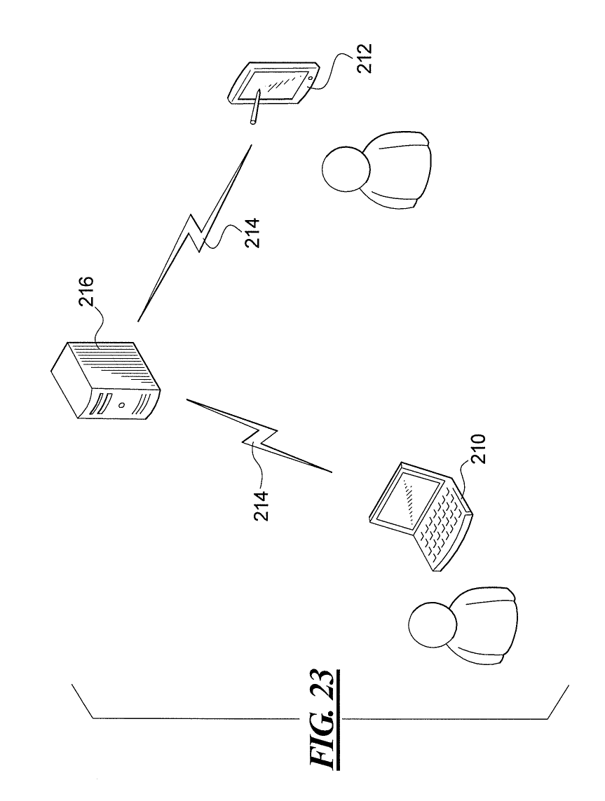

Turning to FIG. 22, a problem of preserving the original values for the search criteria that is being edited is addressed. The criteria values are held in memory and overwrite the filter numbers that the database returns when a filter value is selected. Referring to the earlier example, the database will return the counts for the selected “XDRIVE30I” series filter after the user selects this criteria, but those are replaced by the original snapshot of values. This allows the user to select the additional values in this filter while having the values and counts of all other filters updated live. In FIG. 22 the persisted series 206 which allows the user to select additional values. Note that the additional series are not “checked” denoting that their counts are not part of the selected vehicles. This feature allows for selecting multiple values in a particular attribute while instantly updating counts for all other attributes.

In one embodiment, the present method and system determines how to decipher what the free text strings were entered by the user and how to search in the appropriate database column. Given the large number of records in the database of vehicle sales (in one example, approximately 3 million) it is not possible to search for the free text in all of the columns and rows using traditional queries. For this reason, the distinct values table was developed. The distinct values table is constructed every night and it contains a distinct value for each of the vehicle attributes along with a description of what the value is. In the example, the values contain each of the years (about 80 year), makes (about 50), models (a few hundred), series (a few thousand), etc. Once the table of distinct values was built it contained about 6,000 records from the original 3 million records. FIG. 15 shows a graphical representation of the distinct value table.

The present method and system utilizes free text search processes. When each letter is typed in the free text a query is executed against the distinct values table to try to identify what the typed value is. For example, “Chevrolet” is identified to be a “Make”. Having identified the text allows the system to programmatically search for the value in the appropriate column within the database (i.e. Select Where Make=‘Chevrolet”).

A business rules implementation is provided. Unlimited business rules may be injected into the process. As in the earlier example with the text value “X5” the algorithm found that to be search criteria to be a Model. Knowing that information the system can search what automobile maker (make) that vehicle is mapped to. The system includes a mapping table ASV search suggestion” which contains a column for the make and another for the models. By searching the ASV search suggestion for the makes that are mapped to “X5” Model, the system finds that it is BMW. Knowing the make and model values and with a default search of last 5 years the system has all of the necessary information to search the database for matching vehicles which produced the valued {131} matches in the example.

Additional complexity and business rules as listed in the innovation value above were built and injected into the algorithm execution. For example searching for a year range, overcoming misspelled words, handling homonyms, etc.

The present system and method adjusts valuation based on market conditions. In particular, an adjustment to the average salvage values is made based on current market conditions. A typical average salvage value is determined by taking an average of vehicle sale prices over a defined period such as the last 6 months or 12 months. But given rapid changes in the economy and the market certain prices such as gasoline, steel, new car prices, etc. can influence the selling price of salvage cars. Doing a straight mathematical average does not take into account the most recent market conditions. The present system includes a calculation which adjusts the price of the ASV results based on market conditions. More recent sales are given greater weight than older sales.

The present system and method adjusts the valuation based on the age of the vehicles. The average salvage values are based on the current age of the vehicle. A typical average salvage value is determined by taking an average of vehicle sale prices over a defined period such as the last 12 months or 18 months. But the value of a vehicle changes over time and that change of value is not reflected by a sale price mathematical average. Generally speaking a vehicle sold a year ago will sell for less now. For example, a 2005 Ford Mustang GT sold in 2011 for $5,000 is expected to sell for less in 2012. To continue the example, assuming a similar 2005 Ford Mustang GT sells in 2012 for $4,000 an Average Sale price would be shown as $4,500. But that $4,500 may appear to be inflated because the basic average calculation is not taking into account the depreciation of the 2011 vehicle thus resulting into an inflated ASV. The system performs a calculation that adjusts the price of the ASV results based on current vehicle prices. The prices could come from but not limited to generally accepted vehicle valuations such as Blue Book values, Black Book values, etc.

Thus, there is shown and described a method and system for obtaining an average salvage value of a vehicle that utilizes numerous features to accelerate the value determination for the user.

Although other modifications and changes may be suggested by those skilled in the art, it is the intention of the inventors to embody within the patent warranted hereon all changes and modifications as reasonably and properly come within the scope of their contribution to the art.

We claim:

1. A method for obtaining a value of a damaged or donated vehicle, comprising the steps of:
in a computer, receiving a search request from a user for a vehicle value;
in a computer, interpreting free text search terms from the user describing a vehicle of interest to recognize known search values;
displaying options to the user for options corresponding to recognized known search terms;
in a computer, searching a table of distinct entries of vehicle values, wherein the distinct values are a reduced number of entries derived from a larger database of entries of vehicle values; and
displaying search results from the table of distinct entries, the results being drawn from the table of distinct values.

2. A system for determining an average salvage value of a vehicle, comprising:
a database of vehicle sales including records of vehicle information wherein the information includes sale price and vehicle year and make and model;
a distinct values table derived from the database and containing records of vehicle information having distinct values for at least the vehicle year and make and model;
an autocomplete function operable to automatically complete vehicle information entered into a text field by a user;
an average value function operable to generate an average of sale price for vehicles found in a search of the distinct values table.
